(19) United States
(12) Patent Application Publication
(10) Pub. No.: US 2007/0023528 A1
(43) Pub. Date: Feb. 1, 2007

(54) Aerator of a container having an electronic label and a container having said aerator

(76) Inventors: Sidong He, Shenzhen (CN); Aiqing Zhou, Shenzhen (CN); Shulin Yang, Shenzhen (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/333,446

(22) Filed: Jan. 18, 2006

(30) Foreign Application Priority Data
Jul. 29, 2005 (CN) 200510089238.7

(51) Int. Cl. G06K 19/06; G06K 7/00

(52) U.S. Cl. 235/492; 235/486

(57) ABSTRACT

The present invention provides an aerator of a container comprising an aerator mounted on the side board of the container and an electronic label installed in the interior space of the aerator. The present invention also provides a container comprising a container body, a penetrated hole locating on the side board of the container body, and an aerator installed in the penetrated hole from the outside of the container body. An electronic label is installed in the interior space of the aerator. The electronic label based on the RFID technology is combined with the aerator of the container. Since the electronic label stores the relative data of the containers which can be read by the readers through radio, the container will be automatically identified.

### FIELD OF THE INVENTION

The present invention relates to a large vessel used to store or transport objects or materials. More particularly, the present invention relates to a container.

The present invention also relates to the assembly parts of the container, especially relates to an aerator of the container.

### BACKGROUND OF THE INVENTION

The container transportation is an advanced international standard transportation process. The transportation using the freignt container which can be stacked increases the storage abilities, the effectiveness and decreases the transportation fee. Based on its outstanding features of the high effectiveness, the convenience and security, the container transportation holds the irreplaceable position of the modern transportation industrial.

Along with the blossom global economy and the modern logistic industrial, the efficiency and the traceable information, the feedback of the container transportation turn up to be more and more important nowadays in the container transportation industrial.

Radio Frequency Identification (hereinafter called RFID) is a contactless automatic Identification technology. It automatically recognizes the objects and gains the corresponding data through receiving radio frequency signal. Stages of Identification process runs without any manpower involved, therefore it will be able to work under any badness circumstance. The RFID technology can identify multiple labels simultaneity and be able to identify high-speed movement objects. The whole RFID can operation with high speed and with convenience.

Since the RFID technology identifies the targeted object automatically and gains the relative information with fast and convenience operational process, therefore, the automatic identified container based on electronic label system through the mentioned RFID technology turns up to be the modern management direction of the field. The outstanding features of this process include the high speed and effective transportation control on custom offices, effective logistic control and decrease on the management cost.

Currently, the electronic labels are installed on the unclear installation location of the outside surface of the containers independently, Most of electronic labels are located differently according to the customer requirements, the exterior structure of electronic labels are varies randomly without combining the electronic label into the structure of the containers. The drawback of previous electronic label system includes: the standard manufacturing disability, high possibility of damage and/or destroy rate of the electronic labels during container usage.

In conclusion, the mentioned previous installation methods of the electronic labels using the existing technologies have disadvantages and drawbacks in the current usages and can be improved.

### SUMMARY OF THE INVENTION

It is an object of the present invention to provide an aerator having an electronic label to overcome the disadvantages and drawbacks of existing technologies.

It is another object of the present invention to provide a freight container having the aerator mentioned above.

The present invention constructs the electronic labels into the structure of the container. Based on the RFID technology, the relative container information has been stored inside the electronic label in order to fulfill the automatic Identification requirements.

The present invention provides an aerator of a container comprising an aerator mounted on the side board of the container, an electronic label installed in the interior space of the aerator, and a case mounted between the electronic label and the container to protect the electronic label. The electronic label could be a powerless electronic label and comprises an antenna, a powerless radio frequency processing chip connected to the antenna, and a reflection board installed between the antenna and the container. The electronic label also could be a powered electronic label and comprises an antenna, a processing circuit connected to the antenna and a battery connected to the processing circuit. The processing circuit comprises: a radio frequency signal receiving/sending module connected to the antenna in order to receive and send the radio signals, a signal analyzing module connected to the radio frequency signal receiving/sending module in order to process the received signals, and a power management module connected to the signal analyzing module and the battery and controlling the power supply from the battery to the signal analyzing module.

The present invention also provides a container comprising a container body, a penetrated hole locating on the side board of the container body, and an aerator installed in the penetrated hole from the outside of the container body. An electronic label is installed in the interior space of the aerator. The electronic label could be a powerless electronic label and comprises an antenna, a powerless radio frequency processing chip connected to the antenna, and a reflection board installed between the antenna and the container body. The electronic label also could be a powered electronic label and comprises an antenna, a processing circuit connected to the antenna and a battery connected to the processing circuit. The processing circuit comprises: a radio frequency signal receiving/sending module connected to the antenna in order to receive and send the radio signals, a signal analyzing module connected to the radio frequency signal receiving/sending module in order to process the received signals, and a power management module connected to the signal analyzing module and the battery and controlling the power supply from the battery to the signal analyzing module.

The aerator is a necessary part to be installed on the fixed location of the containers. The electronic label based on the RFID technology is combined with the aerator of the container. Since the electronic label stores the relative data of the containers which can be read by the readers through radio, the container will be automatically identified. The advantages of the present invention as fellow:

Firstly, the electronic label is installed in the existing interior of the aerator with no influence to the current existing container structure. The electronic label with better protection is easy to replace and maintain.

Secondly, because the location of the aerator is just the location of the electronic label, the reading process of the relative data of the containers can be easily completed regardless the reader location actually located on the gates, stacks or suspending bridges. The location of electronic label is physically ideal to collect data in each and every data collection site of the whole logistic chain.

Thirdly, re-construct the electronic label and the aerator together is better for the standard manufacturing and reduces the cost of using electronic label in the container transportation industrial.

### BRIEF DESCRIPTION OF THE DRAWINGS

It will be understood that the drawings are intended to provide assistance to the present invention, which do not constitute a departure from the spirit and scope of the invention.

FIG. 1 is a perspective illustration of the container, the container comprises an aerator;

FIG. 2 is a perspective illustration of the current aerator;

FIG. 3A is a perspective illustration of the aerator of the first embodiment of the present invention, wherein a powerless electronic label is installed in the aerator;

FIG. 3B is the section view of FIG. 3A;

FIG. 3C is the circuit diagram of the powerless electronic label of FIG. 3A;

FIG. 4A is a perspective illustration of the aerator of the second embodiment of the present invention, wherein a powered electronic label is installed in the aerator;

FIG. 4B is the section view of FIG. 4A;

FIG. 4C is the circuit diagram of the powered electronic label of FIG. 4A.

### DESCRIPTION OF THE PREFERRED EMBODIMENT

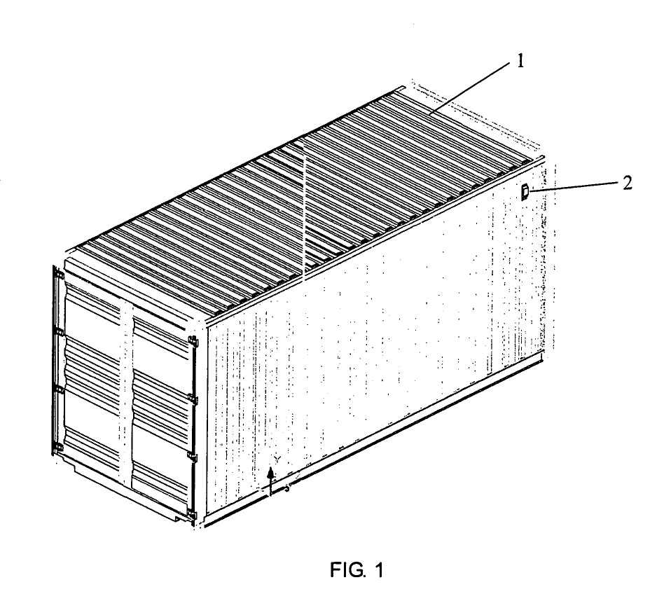

As shown in FIG. 1, the penetrated hole (concealed in FIG. 1) locates nearly on the top of the side board of the container, the aerator 2 is installed in the penetrated hole from the outside of the container 1.

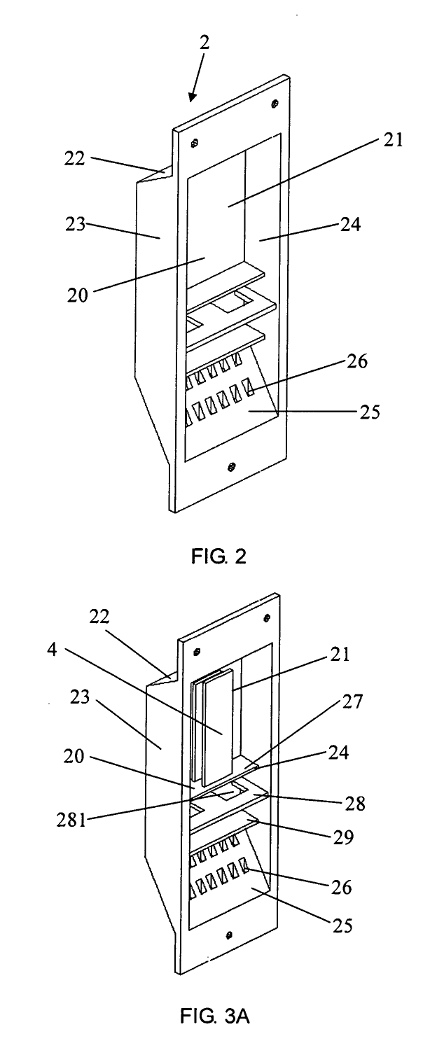

The structure of one of the current aerators is shown as FIG. 2. The UP and DOWN hereinafter refers to the up direction and down direction under the standard upright position of containers. The aerator 2 is a shell which has one erect board 21 and four side boards 22, 23, 24, 25 mounted on the four edges of the erect board 21, wherein the bottom side board 25 has multiple aerated holes 26 and is sloped to the erect board 21. The interior surface of the erect board 21 has three clapboards 27, 28, 29 used to connect the erect side board 23, 24. The middle clapboard 28 have multiple aerated holes, two rectangle holes 281 are shown in FIG. 1. Two gaps occur between the top clapboard 27, bottom clapboard 28 and middle clapboard 29. The interior of the erect board 21 and the side board 22, 23, 24, 25 together form interior space 20.

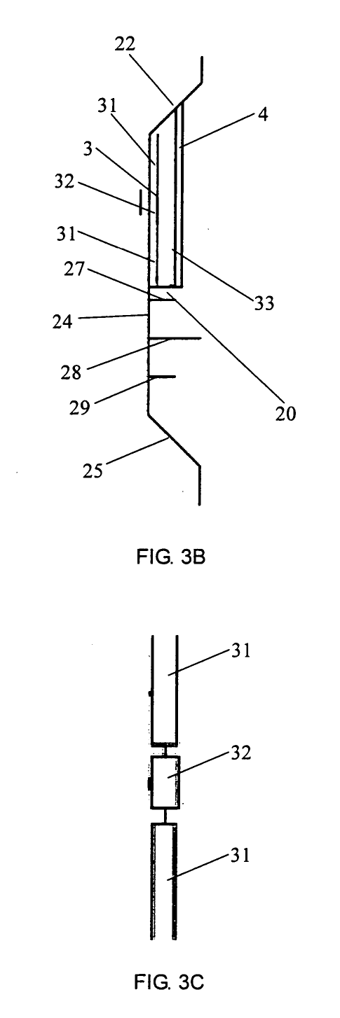

FIG. 3A-3C show the first embodiment of the present invention. An electronic label 3 and a case 4 which can be connected to the top clapboard 27 and the side board 22, 23, 24 and protect the electronic label 3 are installed in the interior space 20. The electronic label 3 is a powerless label, which comprises an antenna 31 and a chip 32 connected to the antenna 31. A reflection board 33 is installed between the electronic label 3 and the case 4. The reflection board 33 is used to amplify the sending/receiving signals. The metal side board of the container can also be used as the reflection board if the case 4 is uninstalled, or the case 4 made of metal can also be used as the reflection board directly. UCODE HSL chip can be used as the powerless radio frequency processing chip, such as Phillips Ucode-18000Hsl-sl3ics30 or as like. UCODE HSL chip is specially designed for powerless smart labeling and the like, which is useful for large read/write distance such as American supply chain applications and logistic management. UCODE HSL is the first smart label being designed based on ISO 180004 and 18000-6 project management standard. The system can provide large read/write distance under the advanced anti-interference and interference technology. At the same time, multiple labels can be process simultaneously within the effective antenna field of the reader. UCODE is specially designed for remote read/write application. When connected to predefined radio frequency antenna, UCODE HSL can work under invisible field with no battery requirement. When the smart label is in the effective field, the high speed frequency communication interface can process dual data transmission. The contactless interface generates power through antenna circuit and the system clock is generated through the internal surge circuit.

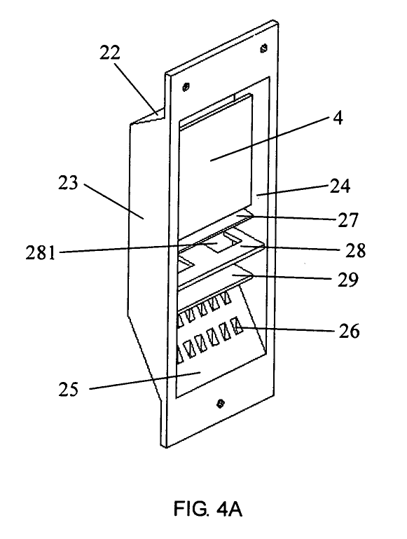

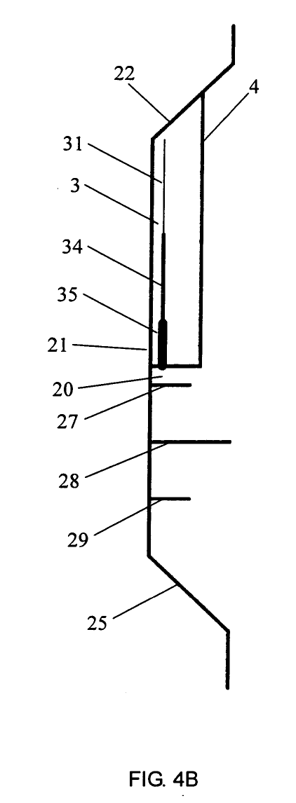

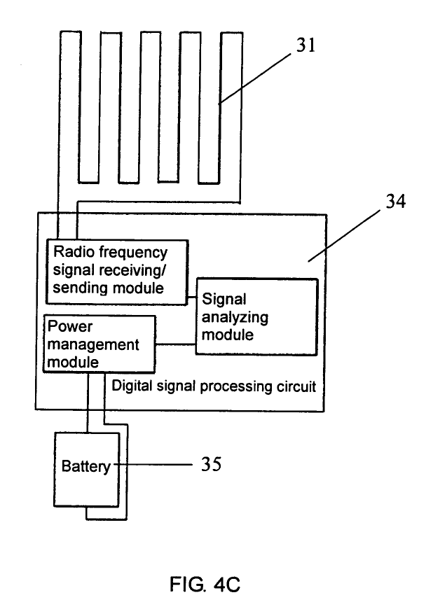

FIG. 4A-4C show the second embodiment of the present invention. An electronic label 3 and a case 4 which can be connected to the top clapboard 27 and the side board 22, 23, 24 and protect the electronic label 3 are installed in the interior space 20. The electronic label 3 is a powered label, which comprises an antenna 31, a processing circuit 34 and a battery 35. The processing circuit 34 comprises: a radio frequency signal receiving/sending module connected to the antenna to process radio frequency signals, an analyzing module which connected to the radio frequency signal receiving/sending module to process the received signal, and a power management module which connected to the signal analyzing module and the battery 35 to control the power supply to the signal analyzing and processing module.

While the present invention has been described in connection with the preferred embodiment of the various figures, it is to be understood that other similar embodiments may be used or modifications and additions may be made to the described embodiment for performing the same function of the present invention without deviating therefore. Therefore, the present invention should not be limited to any single embodiment, but rather construed in breadth and scope in accordance with the recitation of the appended claims.

What is claimed is:

1. An aerator of a container having an electronic label, comprising:
an aerator mounted on the side board of said container, and
an electronic label installed in the interior space of said aerator.

2. The aerator of a container as claimed in claim 1, wherein said electronic label is a powerless electronic label and comprises an antenna and a powerless radio frequency processing chip connected to said antenna.

3. The aerator of a container as claimed in claim 2, wherein said powerless electronic label further comprises a reflection board installed between said antenna and the container body.

4. The aerator of a container as claimed in claim 1, wherein said electronic label is a powered electronic label and comprises an antenna, a processing circuit connected to said antenna and a battery connected to said processing circuit, wherein said processing circuit comprises:
a radio frequency signal receiving/sending module connected to said antenna in order to receive and send the radio signals,
a signal analyzing module connected to said radio frequency signal receiving/sending module in order to process the received signals, and
a power management module connected to said signal analyzing module and said battery and controlling the power supply from said battery to said signal analyzing module.

5. The aerator of a container as claimed in claim 1, further comprising a case mounted between said electronic label and the interior of said container to protect said electronic label.

6. A container, comprising:
a container body, a penetrated hole locating on the side board of said container body, and
an aerator installed in said penetrated hole from the outside of said container body, wherein an electronic label is installed in the interior space of said aerator.

7. The container as claimed in claim 6, wherein said electronic label is a powerless electronic label and comprises an antenna and a powerless radio frequency processing chip connected to said antenna.

8. The container as claimed in claim 7, wherein said powerless electronic label further comprises a reflection board installed between said antenna and said container body.

9. The container as claimed in claim 6, wherein said electronic label is a powered electronic label and comprises an antenna, a processing circuit connected to said antenna and a battery connected to said processing circuit, wherein said processing circuit comprises:
a radio frequency signal receiving/sending module connected to said antenna in order to receive and send the radio signals,
a signal analyzing module connected to said radio frequency signal receiving/sending module in order to process the received signals, and
a power management module connected to said signal analyzing module and said battery and controlling the power supply from said battery to said signal analyzing module.

10. The container as claimed in claim 6, further comprising a case mounted between said electronic label and the interior of said container to protect said electronic label.
